(19) United States
(12) Patent Application Publication
(10) Pub. No.: US 2026/0341809 A1
(43) Pub. Date: Oct. 29, 2026

(54) Connection Detection Circuit, Detection Method, and Battery Management System

(71) Applicant: Joulwatt Technology (Shanghai) Co., Ltd., Shanghai (CN)

(72) Inventor: Yipeng Wang, Shanghai (CN)

(21) Appl. No.: 19/651,515

(22) Filed: Apr. 17, 2026

(30) Foreign Application Priority Data
Apr. 23, 2025 (CN) 202510519706.7

(51) Int. Cl. H01M 10/42

(52) U.S. Cl. CPC H01M 10/425; H01M 2010/4271

(57) ABSTRACT

A battery management system includes a battery pack, and a battery management chip including a main circuit, a first pin, at least one second pin and a third pin. Whether a lowest voltage terminal of the battery pack is connected to the third pin is determined based on the voltage or substrate current of the at least one second pin. When the lowest voltage terminal of the battery pack is not connected to the third pin, the main circuit is controlled to turn off. When the lowest voltage terminal of the battery pack is connected to the third pin, the main circuit is controlled to turn on. This ensures that the main circuit starts to operate after the lowest voltage terminal of the battery pack is connected to third pin of the battery management chip, avoiding causing abnormal output or damage to the chip.

### CROSS-REFERENCE TO RELATED APPLICATIONS

This patent application claims priority to China Patent Application No. 202510519706.7, filed on Apr. 23, 2025 and entitled "CONNECTION DETECTION CIRCUIT, DETECTION METHOD, AND BATTERY MANAGEMENT SYSTEM" which is hereby incorporated by reference herein as if reproduced in its entirety.

### TECHNICAL FIELD

The present disclosure relates generally to the field of power electronics technology, and more particularly, to techniques and mechanisms for a connection detection circuit, a detection method, and a battery management system.

### BACKGROUND

In power battery systems, multiple battery cells are usually used to form a battery pack to achieve high voltage output. Due to the large number of individual battery cells and the differences in performance parameters of the battery cells, the safety and lifespan of the power battery pack are greatly affected. Therefore, a battery management system (BMS) is usually used to manage the battery pack.

During the assembly of the battery pack with the battery management chip of the battery management system, because it is difficult to keep a fixed power-on sequence, when the lowest voltage terminal of the battery pack is not connected to the battery management chip, but common terminals between the batteries of the battery pack are arbitrarily connected to the battery management chip, substrate current or negative voltage will appear at the relevant pins of the battery management chip that are connected to the battery pack, which will affect the circuits inside the battery management chip, causing abnormal output, and in severe cases, chip damage.

### SUMMARY

An objective of the present disclosure is to provide a connection detection circuit, a detection method, and a battery management system, which ensure that circuits inside a battery management chip of the battery management system start to operate after a lowest voltage terminal of a battery pack is connected to the battery management chip, without causing abnormal output or even damage to the chip.

In a first aspect, embodiments of the present disclosure provide a connection detection circuit applied to a battery management system, the battery management system includes a battery pack and a battery management chip, the battery pack includes at least two battery cells, the battery management chip includes a main circuit, a first pin, at least one second pin and a third pin, the third pin is connected to a reference ground of the main circuit, the first pin is configured to connect to a highest voltage terminal of the battery pack, the at least one second pin is configured to connect to a battery negative terminal of the battery pack, and the third pin is configured to connect to a lowest voltage terminal of the battery pack. The connection detection circuit is configured to detect a voltage or a substrate current of the at least one second pin to output a control signal indicating whether the lowest voltage terminal of the battery pack is connected to the third pin. When the control signal indicates that the lowest voltage terminal of the battery pack is not connected to the third pin, the main circuit is controlled to be turned off. When the control signal indicates that the lowest voltage terminal of the battery pack is connected to the third pin, the main circuit is controlled to be turned on.

Optionally, the at least one second pin is configured to connect to a common terminal between batteries in the battery pack; or, one of the at least one second pins is configured to connect to the lowest voltage terminal of the battery pack, and other second pin(s) is/are configured to connect to common terminal(s) between the batteries in the battery pack.

Optionally, each second pin is connected to a substrate parasitic diode, when a negative voltage is detected at the at least one second pin, or when the substrate current is detected flowing through at least one substrate parasitic diode, it is determined that the lowest voltage terminal of the battery pack is not connected to the third pin; otherwise, it is determined that the lowest voltage terminal of the battery pack is connected to the third pin.

Optionally, the connection detection circuit includes: at least one comparison module, the at least one comparison module corresponding one-to-one with the at least one second pin, and each comparison module being used to receive the voltage of a corresponding second pin or receive a first signal indicating the substrate current of the corresponding second pin, and output a comparison signal; and a logic processing circuit, which is used to receive the comparison signal output by the at least one comparison module, perform logic processing, and output the control signal.

Optionally, when a comparison module receives the voltage of the corresponding second pin, the comparison module includes a comparison circuit, a first input terminal of the comparison circuit receives the voltage of the second pin, and a second input terminal receives a first reference signal, and the voltage of the second pin and the first reference signal are compared to output a comparison signal; or, the comparison module includes a first voltage source and a comparison circuit, a first polarity terminal of the first voltage source receives the voltage of the second pin, and a second polarity terminal outputs a first superimposed voltage obtained by superimposing the voltage of the second pin and the voltage of the first voltage source, a first input terminal of the comparison circuit receives the first superimposed voltage, a second input terminal receives a second reference signal, and the first superimposed voltage and the second reference signal are compared to output a comparison signal; or, the comparison module includes a first adder and a comparison circuit, the first adder is configured to add the voltage of the second pin and a bias voltage to output a second superimposed voltage, a first input terminal of the comparison circuit receives the second superimposed voltage, a second input terminal receives a third reference signal, and the second superimposed voltage and the third reference signal are compared to output a comparison signal.

Optionally, when a comparison module receives the first signal, the comparison module includes: a current amplification circuit connected to the third pin and the second pin to receive the first signal and amplify the first signal to obtain a current amplification signal indicating the substrate current of the corresponding second pin; and a comparison circuit having a first input terminal receiving the current amplification signal and a second input terminal receiving a fourth reference signal, wherein the comparison circuit is configured to compare the current amplification signal and the fourth reference signal to output a comparison signal.

Optionally, the current amplification circuit includes: a transistor, having a control terminal connected to the third pin, a first terminal connected to the second pin, and a second terminal connected to the first input terminal of the comparison circuit, wherein the current amplification signal is obtained based on the current flowing through the transistor.

Optionally, the main circuit includes an enable signal input terminal, the enable signal input terminal is used to receive the control signal, and the control signal is used to control whether the main circuit is enabled.

Optionally, the battery management system includes a first switch, the first switch is connected between the main circuit and the first pin; the control signal controls the first switch to open when the lowest voltage terminal of the battery pack is not connected to the third pin, so as to shut down the main circuit; and the control signal controls the first switch to close when the lowest voltage terminal of the battery pack is connected to the third pin, so as to turn on the main circuit.

In a second aspect, embodiments of the present disclosure also provide a connection detection method applied to a battery management system, the battery management system includes a battery pack and a battery management chip, the battery pack includes at least two battery cells, and the battery management chip includes a main circuit, a first pin, at least one second pin and a third pin, the first pin being configured to connect to a highest voltage terminal of the battery pack, the at least one second pin being configured to connect to a common terminal between batteries in the battery pack, and the third pin being configured to connect to a lowest voltage terminal of the battery pack. The method includes: detecting a voltage or a substrate current of the at least one second pin to determine whether the lowest voltage terminal of the battery pack is connected to the third pin; when determining that the lowest voltage terminal of the battery pack is not connected to the third pin, controlling the main circuit to turn off; when determining that the lowest voltage terminal of the battery pack is connected to the third pin, controlling the main circuit to turn on.

Optionally, each second pin is connected to a substrate parasitic diode, detecting the voltage or the substrate current of the at least one second pin to determine whether the lowest voltage terminal of the battery pack is connected to the third pin includes: when detecting that the voltage of the at least one second pin is negative, or when detecting that the substrate current flows through the at least one substrate parasitic diode, determining that the lowest voltage terminal of the battery pack is not connected to the third pin; and otherwise, determining that the lowest voltage terminal of the battery pack is connected to the third pin.

Optionally, detecting the voltage or the substrate current of the at least one second pin to determine whether the lowest voltage terminal of the battery pack is connected to the third pin includes: respectively comparing the voltage of the at least one second pin with a first reference signal to obtain at least one comparison result; or, respectively superimposing the voltage of the at least one second pin with a first voltage source to obtain at least one first superimposed voltage, and respectively comparing the at least one first superimposed voltage with a second reference signal to obtain at least one comparison result; or, respectively adding the voltage of the at least one second pin to a bias voltage to obtain at least one second superimposed voltage, and respectively comparing the at least one second superimposed voltage with a third reference signal to obtain at least one comparison result; or, respectively amplifying at least one first signal representing the substrate current of the at least one second pin to obtain at least one amplified current signal respectively representing the substrate current of the at least one second pin, and respectively comparing the at least one current amplified signal with a fourth reference signal to obtain at least one comparison result; and determining whether the lowest voltage terminal of the battery pack is connected to the third pin based on the at least one comparison result.

In a third aspect, embodiments of the present disclosure also provide a battery management chip, including a main circuit, a first pin, at least one second pin and a third pin, and the connection detection circuit as described above.

In a fourth aspect, embodiments of the present disclosure also provide a battery management system, including the battery management chip as described above.

In a fifth aspect, embodiments of the present disclosure also provide a battery management system, including the battery pack and the battery management chip as described above.

According to one further aspect of the present disclosure, a circuit applied to a battery management system is provided. The battery management system includes a battery pack and a battery management chip, the battery pack includes at least two batteries, the battery management chip includes a main circuit, a first pin, at least one second pin and a third pin, and the third pin is connected to a reference ground of the main circuit. The first pin is configured to connect to a highest voltage terminal of the battery pack, the at least one second pin is configured to connect to a negative terminal of a battery in the battery pack, and the third pin is configured to connect to a lowest voltage terminal of the battery pack. The circuit includes at least one comparison module corresponding one-to-one to the at least one second pin, and the at least one comparison module is configured to output at least one comparison signal based on a voltage or a substrate current of the at least one second pin. The circuit is configured to: generate a control signal indicating whether the lowest voltage terminal of the battery pack is connected to the third pin based on the at least one comparison signal; when the control signal indicates that the lowest voltage terminal of the battery pack is not connected to the third pin, control to turn off the main circuit; and when the control signal indicates that the lowest voltage terminal of the battery pack is connected to the third pin, control to turn on the main circuit.

According to another aspect of the present disclosure, a method applied to a battery management system is provided. The battery management system includes a battery pack and a battery management chip, the battery pack includes at least two batteries, and the battery management chip includes a main circuit, a first pin, at least one second pin and a third pin, the first pin is configured to connect to a highest voltage terminal of the battery pack, the at least one second pin is configured to connect to a common terminal between the at least two batteries of the battery pack, and the third pin is configured to connect to a lowest voltage terminal of the battery pack. The method includes: detecting a voltage or a substrate current of the at least one second pin, and based thereon, determining whether the lowest voltage terminal of the battery pack is connected to the third pin; when determining that the lowest voltage terminal of the battery pack is not connected to the third pin, controlling to turn off the main circuit; and when determining that the lowest voltage terminal of the battery pack is connected to the third pin, controlling to turn on the main circuit.

According to yet another aspect, a battery management chip is provided that includes: a first pin, configured to connect to a highest voltage terminal of a battery pack; at least one second pin, configured to connect to a negative terminal of a battery of the battery pack; a third pin, configured to connect to a lowest voltage terminal of the battery pack; a main circuit, connected to the first pin and the at least one second pin, wherein the third pin is connected to a reference ground of the main circuit; and a detection circuit connected to the at least one second pin and the main circuit, the detection circuit being configured to: generate a control signal indicating whether the lowest voltage terminal of the battery pack is connected to the third pin, based on a voltage or a substrate current of the at least one second pin; when the control signal indicates that the lowest voltage terminal of the battery pack is not connected to the third pin, control to turn off the main circuit; and when the control signal indicates that the lowest voltage terminal of the battery pack is connected to the third pin, control to turn on the main circuit.

The connection detection circuit, the detection method, and the battery management system provided by the present disclosure detect the voltage or the substrate current of the at least one second pin to determine whether the lowest voltage terminal of the battery pack is connected to the third pin. When it is determined that the lowest voltage terminal of the battery pack is not connected to the third pin, the main circuit is controlled to turn off, and when it is determined that the lowest voltage terminal of the battery pack is connected to the third pin, the main circuit is controlled to turn on. Therefore, by detecting the voltage or the substrate current of each second pin in the battery management chip, it is determined whether the lowest voltage terminal of the battery pack is connected to the third pin of the battery management chip, thereby controlling the shut-down and turn-on of the main circuit of the battery management chip, which ensures that the circuits inside the battery management chip start to operate after the lowest voltage terminal of the battery pack is connected to the battery management chip, without causing abnormal output or even damage to the chip.

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures or processes for carrying out the same purposes of the present disclosure. It should also be realized by those skilled in the art that such equivalent constructions do not depart from the spirit and scope of the disclosure as set forth in the appended claims.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 is a schematic structural diagram of a battery management system of existing technology;

FIG. 2 is a schematic structural diagram of another battery management system of existing technology;

FIG. 3 is a schematic structural diagram of another battery management system of existing technology;

FIG. 4 is a schematic structural diagram of a battery management system in Embodiment 1 of the present disclosure;

FIG. 5 is a schematic structural diagram of a battery management system in Embodiment 2 of the present disclosure;

FIG. 6 is a schematic structural diagram of a battery management system in Embodiment 3 of the present disclosure;

FIG. 7 is a schematic structural diagram of a battery management system in Embodiment 4 of the present disclosure;

FIG. 8 is a schematic structural diagram of a battery management system in Embodiment 5 of the present disclosure;

FIG. 9 is a schematic structural diagram of a comparison module in FIG. 8;

FIG. 10 is another schematic structural diagram of the comparison module in FIG. 8;

FIG. 11 is yet another schematic structural diagram of the comparison module in FIG. 8;

FIG. 12 is yet another structural schematic diagram of the comparison module in FIG. 8; and

FIG. 13 is a structural schematic diagram of a connection detection circuit according to embodiments of the present disclosure.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of embodiments of this disclosure are discussed in detail below. It should be appreciated, however, that the concepts disclosed herein can be embodied in a wide variety of specific contexts, and that the specific embodiments discussed herein are merely illustrative and do not serve to limit the scope of the claims. Further, it should be understood that various changes, substitutions and alterations can be made herein without departing from the spirit and scope of this disclosure as defined by the appended claims.

Furthermore, one or more features from one or more of the following described embodiments may be combined to create alternative embodiments not explicitly described, and features suitable for such combinations are understood to be within the scope of this disclosure. It is therefore intended that the appended claims encompass any such modifications or embodiments.

Embodiments of the present disclosure will be described in detail below with reference to the accompanying drawings, but the present disclosure is not limited to these specific embodiments. The present disclosure covers any substitutions, modifications, equivalent methods, and solutions made within the spirit and scope of the present disclosure.

To facilitate a thorough understanding of the present disclosure, specific details are described in detail in the following embodiments of the present disclosure, but those skilled in the art may fully understand the present disclosure without these details.

The present disclosure is described more specifically in the following paragraphs by way of example with reference to the accompanying drawings. It should be noted that the drawings are in a simplified form and do not use precise proportions, to facilitate and clearly assist in illustrating the purpose of the embodiments of the present disclosure.

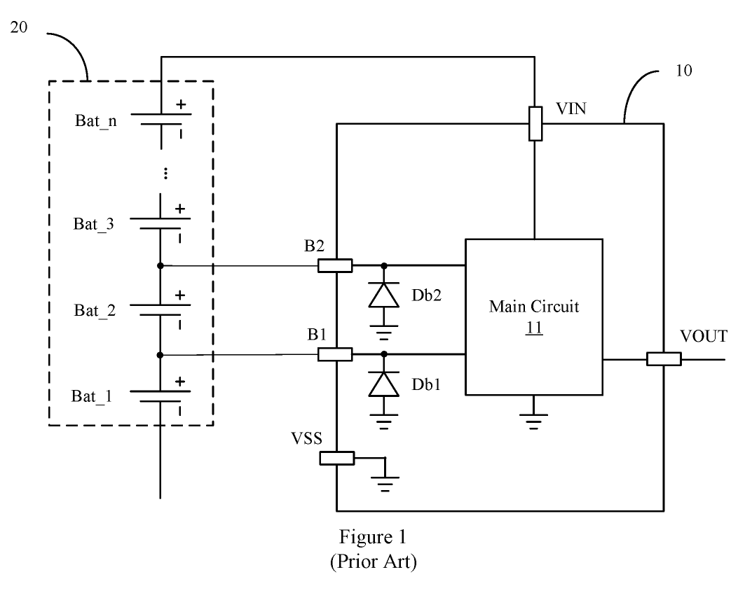

As shown in FIG. 1, in existing technology, during the assembly process of a battery pack 20 and a battery management chip 10, where the battery pack 20 is composed of battery Bat_1, battery Bat_2, battery Bat_3, ..., and battery Bat_n, due to the difficulty of fixing the power-on sequence, when the lowest voltage terminal of the battery pack 20 (a terminal of the battery pack 20 having the lowest voltage), i.e., the negative terminal of battery Bat_1, is not connected to the VSS pin of the battery management chip 10, and the common terminals between batteries of the battery pack 20, such as common terminals between battery Bat_1 and battery Bat_2, between battery Bat_2 and battery Bat_3, and so on, are arbitrarily connected to pins of the battery management chip 10, such as pins B1, B2, and so on, substrate current or negative voltage may be caused to appear on relevant pins of the battery management chip 10 connected to the battery pack 20, such as B1 pin or B2 pin, which may affect a main circuit 11 in the battery management chip 10, causing abnormal output of the battery management chip 10, and in severe cases, even damaging the chip. For illustration convenience, the terms "battery management chip" and "chip" may be used interchangeably.

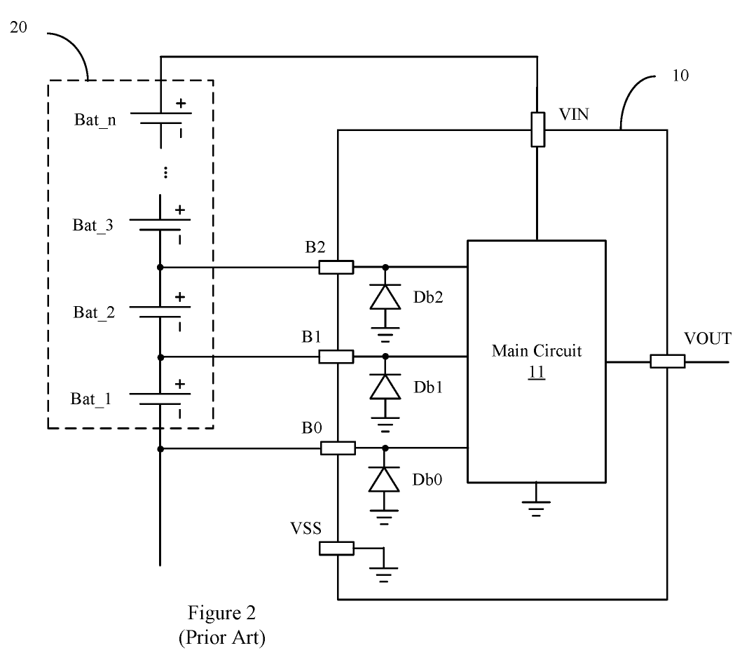

A battery management system in existing technology may also be as shown in FIG. 2, where the lowest voltage terminal of a battery pack 20 is configured to connect to B0 pin and VSS pin of a battery management chip 10. In this case, if the lowest voltage terminal of the battery pack 20 is not connected to the VSS pin of the battery management chip 10, and the negative terminals of batteries in the battery pack 20 are arbitrarily connected to pins such as B0, B1, and B2, substrate current or negative voltage may also be caused to appear on the relevant pins such as B0, B1, or B2, thereby affecting a main circuit 11, causing abnormal output, and in severe cases, even damaging the chip.

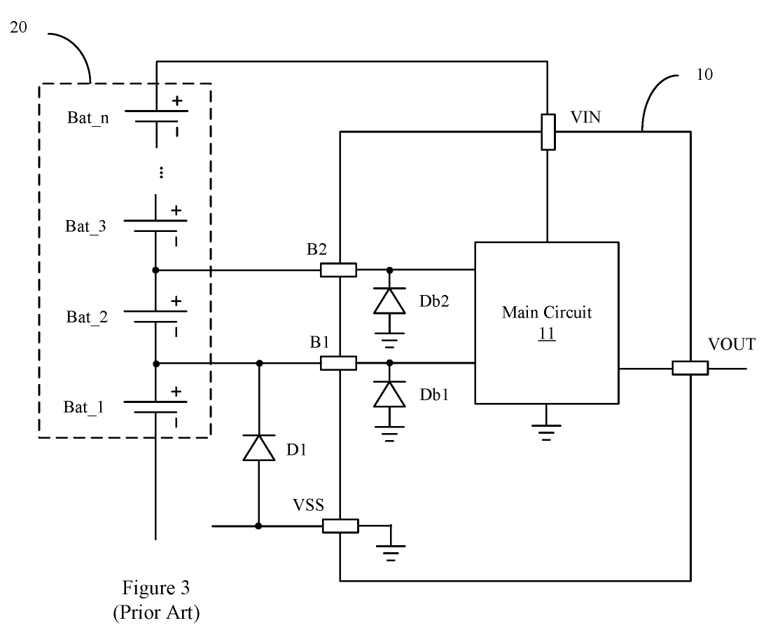

To address the issues mentioned above, a common solution in the existing technology is to add protective devices, such as Schottky diodes, to relevant nodes of connection lines between the battery pack and the battery management chip, such that the voltages of the relevant pins of the battery management chip connected to the battery pack may be clamped to be above -0.3V. For example, as shown in FIG. 3, when the lowest voltage terminal of the battery pack 20 is not connected to the VSS pin, and the common terminals between battery Bat_1 and battery Bat_2, and between battery Bat_2 and battery Bat_3, are connected to pins B1 and B2, respectively, in the existing technology, a Schottky diode D1 is usually connected between pin B1 and the VSS pin externally to the battery management chip 10, in order to clamp the voltage of pin B1 above -0.3V. However, this technical solution increases cost due to the external protective device added to the battery management chip, and leakage current may occur after the addition of the Schottky diode, affecting chip performance.

To address the issues mentioned above, embodiments of the present disclosure provide a connection detection circuit, a detection method, and a battery management system, which, by detecting the voltage or substrate current of at least one second pin of a battery management chip, determines whether the lowest voltage terminal of a battery pack is connected to the third pin of the battery management chip. When it is determined that the lowest voltage terminal of the battery pack is not connected to the third pin, the main circuit is controlled to turn off, and when it is determined that the lowest voltage terminal of the battery pack is connected to the third pin, the main circuit is controlled to turn on. In this way, it is ensured that the circuits inside the battery management chip start to operate after the lowest voltage terminal of the battery pack is connected to the battery management chip, which avoids causing abnormal output or even damaging the chip. Further, no additional protection device is required outside the battery management chip, which reduces cost.

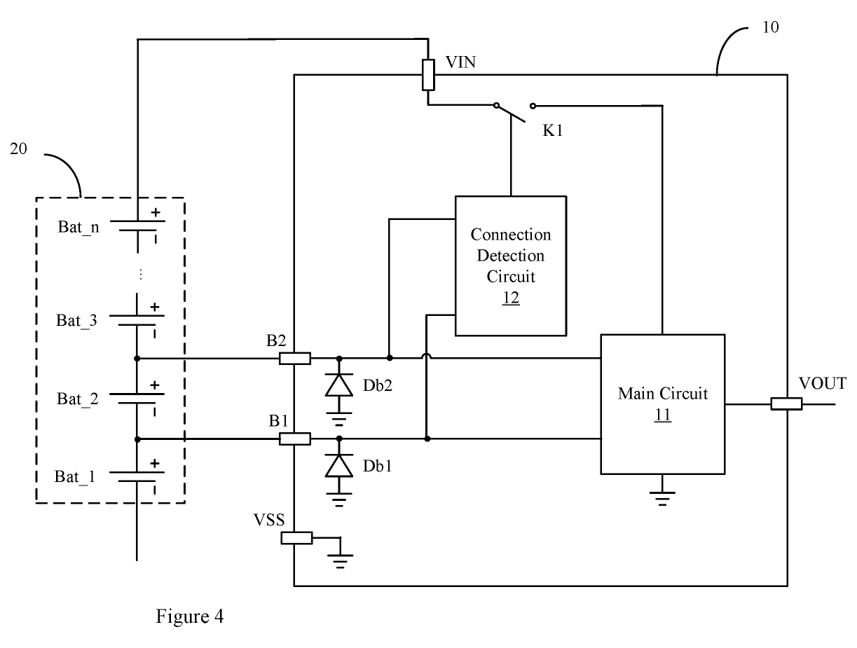

FIG. 4 shows a schematic structural diagram of a circuit of a battery management system according to Embodiment 1 of the present disclosure. As shown in FIG. 4, the battery management system may include a battery management chip 10 and a battery pack 20. The battery pack 20 includes battery Bat_1, battery Bat_2, battery Bat_3, ..., and battery Bat_n. The battery management chip 10 includes a main circuit 11, a connection detection circuit 12, a first pin VIN, second pins B1 and B2 (the second pins may include more pins in addition to B1 and B2), a third pin VSS, and a VOUT pin. The battery management chip 10 may include at least one second pin.

The highest voltage terminal of the battery pack 20 (a terminal of the battery pack 20 having the highest voltage), i.e., the positive terminal of battery Bat_n, is configured to connect to the first pin VIN. The common terminals between batteries in the battery pack 20, i.e. the common terminals between battery Bat_1 and battery Bat_2 and battery Bat_2 and battery Bat_3 as shown in this example, are connected to the second pins B1 and B2, respectively. The lowest voltage terminal of the battery pack 20, i.e. the negative terminal of battery Bat_1, is connected to the third pin VSS. The third pin VSS is connected to the reference ground of the main circuit 11, and the main circuit 11 is connected to the VOUT pin.

The connection detection circuit 12 is connected to the second pins such as B1 and B2, and is configured to detect the voltage or substrate current of the second pins B1 and B2, to output a control signal that indicates whether the lowest voltage terminal of the battery pack 20, i.e. the negative terminal of battery Bat_1, is connected to the third pin VSS. When the control signal indicates that the lowest voltage terminal of the battery pack 20 is not connected to the third pin VSS, the connection detection circuit 12 may control the main circuit 11 to turn off, and when the control signal indicates that the lowest voltage terminal of the battery pack 20 is connected to the third pin VSS, the connection detection circuit 12 may control the main circuit 11 to turn on.

As an example, when the control signal is high, it may be determined that the lowest voltage terminal of the battery pack 20 is not connected to the third pin VSS, and the main circuit 11 may be controlled to turn off. When the control signal is low, it may be determined that the lowest voltage terminal of the battery pack 20 is connected to the third pin VSS, and the main circuit 11 may be controlled to turn on.

It should be noted that in the embodiments of the present disclosure, the common terminals between battery Bat_1 and battery Bat_2 and between battery Bat_2 and battery Bat_3 are connected to the second pins B1 and B2 respectively, which is merely taken as an example in order to illustrate the technical solution of the present disclosure. The connection between the battery pack 20 and the battery management chip 10 of the present disclosure is actually not limited thereto. For example, when the battery pack 20 includes n batteries (or n battery cells), the connection between the battery pack 20 and the second pin of the battery management chip 10 may be that the common terminal between battery Bat_1 and battery Bat_2 is connected to the second pin B1, the common terminal between battery Bat_2 and battery Bat_3 is connected to the second pin B2, the common terminal between battery Bat_3 and battery Bat_4 is connected to the second pin B3, the common terminal between battery Bat_4 and battery Bat_5 is connected to the second pin B4, ..., and the common terminal between battery Bat_n-1 and battery Bat_n is connected to the second pin Bn-1.

It should also be noted that the main circuit 11 may be a Low-Drop Out regulator (LDO), a power supply circuit, or one or more circuits of the battery management chip used for current acquisition, voltage acquisition, or power output, which is not limited herein.

In this embodiment, the battery management system may further include a first switch K1, and the first switch K1 is connected between the main circuit 11 and the first pin VIN. Upon receiving the control signal, the first switch K1 may be controlled by the control signal to open when the lowest voltage terminal of the battery pack 20 is not connected to the third pin VSS, such that the main circuit 11 is turned off; and to close when the lowest voltage terminal of the battery pack 20 is connected to the third pin VSS, such that the main circuit 11 is turned on.

In an example, the first switch K1 may be a switching transistor. The switching transistor may be a Metal-Oxide-Semiconductor Field-Effect Transistor (MOSFET) or a Bipolar Junction Transistor (BJT).

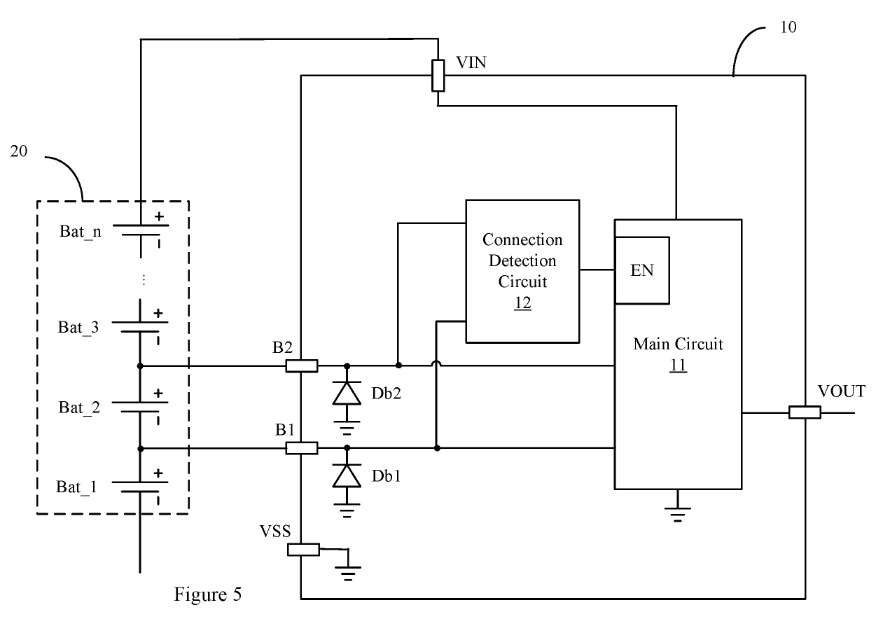

In one embodiment (Embodiment 2), as shown in FIG. 5, the main circuit 11 may include an enable signal input terminal EN. The enable signal input terminal EN is configured to receive the control signal, which is used to control whether the main circuit 11 is enabled. For example, when the control signal is high, the main circuit 11 may be controlled to be enabled; and when the control signal is low, the main circuit 11 may be controlled to be disabled.

Optionally, the detection logic of the connection detection circuit 12 may be as follows: after the battery management chip 10 is started, the connection detection circuit 12 is started and the main circuit 11 is turned off. The connection detection circuit 12 detects the voltages or substrate currents of the second pins B1 and B2, and determines whether there is a negative voltage or substrate current at the second pins B1 and B2. When it is determined that there is a negative voltage or substrate current at the second pins B1 and B2, the main circuit 11 is kept off, and the connection detection circuit 12 continues to detect and determine the voltages or substrate currents of the second pins B1 and B2, until there is no negative voltage or substrate current at the second pins B1 and B2, at which time, the main circuit 11 is turned on and the battery management chip 10 operates normally.

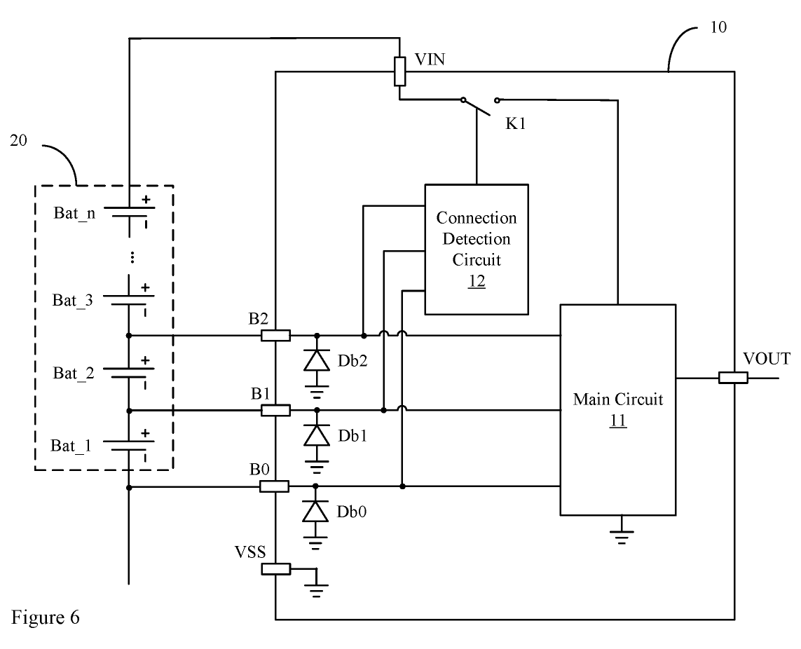

In one embodiment (Embodiment 3), the circuit structure of the battery management system of the present disclosure may also be as shown in FIG. 6, where the negative terminals of the batteries in the battery pack 20, i.e., the negative terminal of battery Bat_1, and the common terminals between battery Bat_1 and battery Bat_2 and between battery Bat_2 and battery Bat_3, are connected to the second pins B0, B1, and B2, respectively, and the lowest voltage terminal of the battery pack 20 is connected to the VSS pin of the battery management chip 10. In this case, the connection detection circuit 12 may determine whether the lowest voltage terminal of the battery pack 20 is connected to the third pin VSS by detecting the voltages or substrate currents of the second pins B0, B1, and B2, thereby controlling the main circuit 11 to turn off or on.

Each of the second pins B0, B1, and B2 is connected to a substrate parasitic diode, for example, the second pin B0 is connected to a substrate parasitic diode Db0, the second pin B1 is connected to a substrate parasitic diode Db1, and the second pin B2 is connected to a substrate parasitic diode Db2. When detecting that at least one of the second pins B0, B1, or B2 has a negative voltage, or when detecting that at least one of the substrate parasitic diodes Db0, Db1, or Db2 has a substrate current flowing through, it may be determined that the lowest voltage terminal of the battery pack 20 is not connected to the third pin VSS; otherwise, it may be determined that the lowest voltage terminal of the battery pack 20 is connected to the third pin VSS. That is, when none of the second pins has a negative voltage and when none of the substrate parasitic diodes has a substrate current flowing through, it is determined that the lowest voltage terminal of the battery pack 20 is connected to the third pin VSS.

It should be noted that the detailed description of the specific working principle of the connection detection circuit 12 below is based on the battery management system shown in FIG. 4, and the connection detection circuit 12 described below is also applicable to the battery management system in FIG. 6.

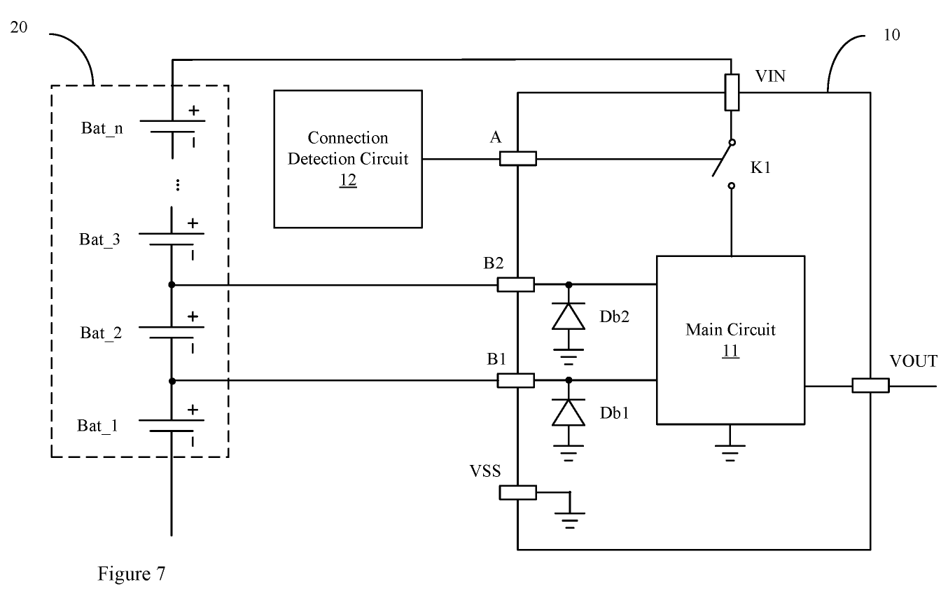

In one embodiment (Embodiment 4), as shown in FIG. 7, the connection detection circuit 12 may also be disposed outside the battery management chip 10 and connected to the battery management chip 10 through a pin A. The connection detection circuit 12 in the present embodiment is configured to achieve the same functions as the connection detection circuit 12 in FIG. 4 and will not be repeated herein.

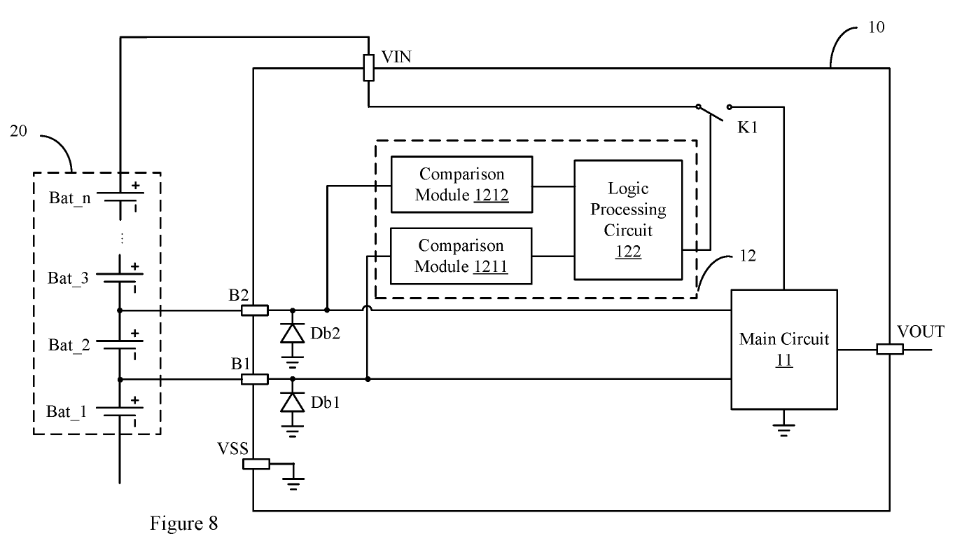

As shown in FIG. 8, in an embodiment (Embodiment 5), the connection detection circuit 12 may include comparison modules such as comparison modules 1211 and 1212, and a logic processing circuit 122. The number of the comparison modules may be the same as that of the second pins, such as B1, B2, etc. The following description is provided taking the comparison modules 1211 and 1212 as examples. The comparison modules 1211 and 1212 are configured to respectively receive the voltages of the corresponding second pins B1 and B2, or to respectively receive first signals indicating respectively the substrate currents of the corresponding second pins B1 and B2, and output comparison signals. The logic processing circuit 122 is configured to receive the comparison signals output by the comparison modules 1211 and 1212, perform logic processing, and output control signals.

Optionally, in some embodiments, after receiving the comparison signals output by the comparison modules 1211 and 1212, the logic processing circuit 122 may first perform filtering processing of the comparison signals respectively and then perform logic processing on the filtered comparison signals to output the control signals.

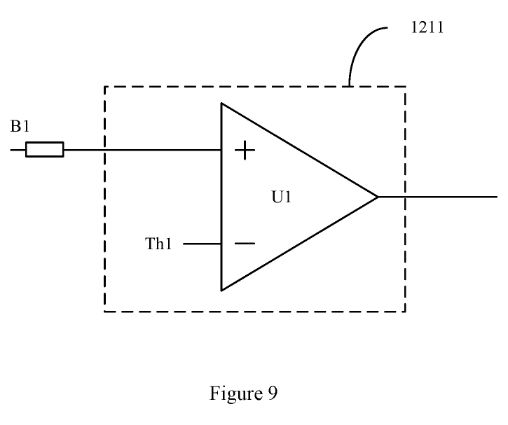

In some embodiments, as shown in FIG. 9, when the comparison module 1211 receives the voltage of the corresponding second pin B1, the comparison module 1211 may include a comparison circuit U1. A first input terminal (e.g., the positive terminal) of the comparison circuit U1 may receive the voltage of the second pin B1, and a second input terminal (e.g., the negative terminal) of the comparison circuit U1 may receive a first reference signal Th1. The comparison circuit U1 compares the voltage of the second pin B1 with the first reference signal Th1 to output a comparison signal.

Optionally, when the lowest voltage terminal of the battery pack 20 is not connected to the third pin VSS, and the common terminals between Battery_1 and Battery_2 and between Battery_2 and Battery_3 are connected to the second pins B1 and B2, respectively, the voltage of the second pin B1 is negative, the first reference signal Th1 may be set to a negative voltage smaller than the voltage of the second pin B1. For example, when the voltage of the second pin B1 is equal to -0.7V, the first reference signal Th1 may be set to -0.8V.

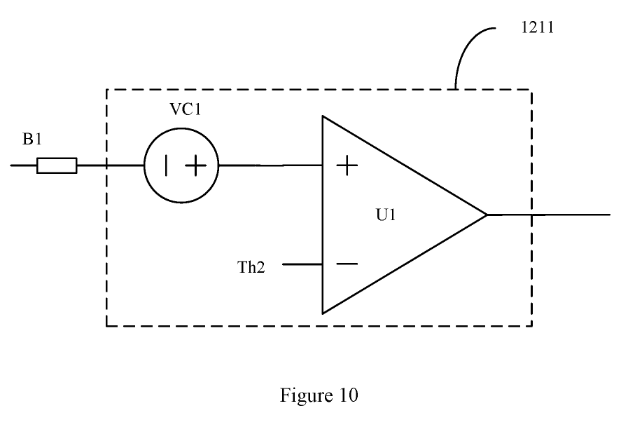

In another embodiment, as shown in FIG. 10, when the comparison module 1211 receives the voltage of the corresponding second pin B1, the comparison module 1211 may include a first voltage source VC1 and a comparison circuit U1. The first polarity terminal of the first voltage source VC1 is connected to the second pin B1 and receives the voltage of the second pin B. The second polarity terminal of the first voltage source VC1 outputs a first superimposed voltage, which is the voltage of the second pin B1 superimposed on the voltage of the first voltage source VC1. The first input terminal (e.g., the positive terminal) of the comparison circuit U1 may receive the first superimposed voltage, the second input terminal (e.g., the negative terminal) of the comparison circuit U1 may receive a second reference signal Th2. The comparison circuit U1 compares the first superimposed voltage and the second reference signal Th2 to output a comparison signal.

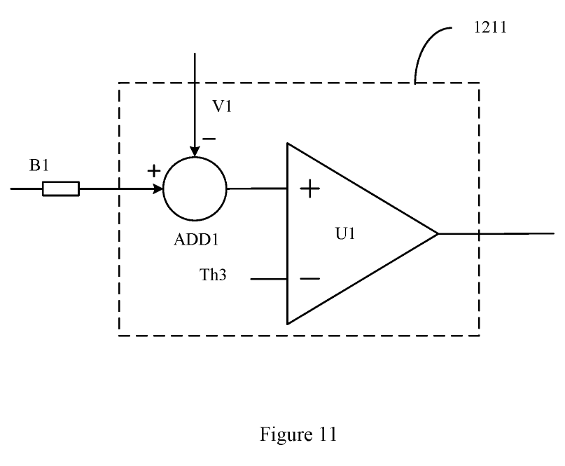

In another embodiment, as shown in FIG. 11, when the comparison module 1211 receives the voltage of the corresponding second pin B1, the comparison module 1211 may include a first adder ADD1 and a comparison circuit U1. The first adder ADD1 is configured to add the voltage of the second pin B1 and a bias voltage V1 to output a second superimposed voltage. The first input terminal (e.g., the positive terminal) of the comparison circuit U1 may receive the second superimposed voltage, the second input terminal (e.g., the negative terminal) of the comparison circuit U1 may receive a third reference signal Th3. The comparison circuit U1 compares the second superimposed voltage and the third reference signal Th3 to output a comparison signal.

As an example, the first voltage source VC1 and the bias voltage V1 may each be a voltage of 0 ~ 6V, and in this case, the second input terminal of the comparison circuit U1 may be connected to the reference ground of the chip.

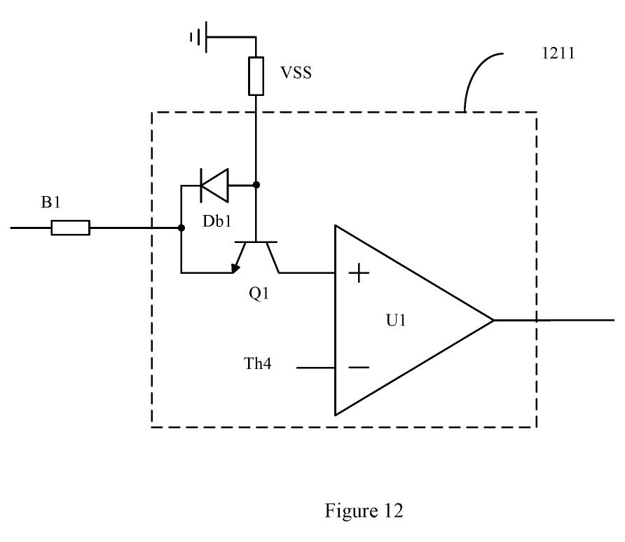

In another embodiment, as shown in FIG. 12, when the comparison module 1211 receives a first signal indicating the substrate current of the corresponding second pin B1, the comparison module 1211 may include a current amplification circuit Q1 and a comparison circuit U1. The current amplification circuit Q1 is connected to the third pin VSS and the second pin B1 to receive the first signal and amplify the first signal to obtain an amplified current signal indicating the substrate current of the corresponding second pin B1. The first input terminal (e.g., the positive terminal) of the comparison circuit U1 may receive the amplified current signal, the second input terminal (e.g., the negative terminal) may receive a fourth reference signal Th4. The comparison circuit U1 compares the current amplified signal and the fourth reference signal Th4 to output a comparison signal.

In some embodiments, the current amplification circuit Q1 may include a transistor, which is also referenced using Q1 for illustration simplicity in the following (e.g., transistor Q1). The control terminal of the transistor Q1 is connected to the third pin VSS, a first terminal of the transistor Q1 is connected to the second pin B1, and a second terminal of the transistor Q1 is connected to the first input terminal of the comparison circuit U1. The amplified current signal indicating the substrate current of the second pin B1 is obtained based on the current flowing through the transistor Q1.

In an example, in the embodiment, the transistor Q1 may be an NPN transistor. The base (B) of the transistor Q1 is connected to the anode of the substrate parasitic diode Db1 and the reference ground, the collector (C) of the transistor Q1 is connected to the positive input terminal of the comparison circuit U1, and the emitter (E) of the transistor Q1 is connected to the second pin B1 and the cathode of substrate parasitic diode Db1. When a substrate current flows through the substrate parasitic diode Db1, current may flow through the BE terminals of the transistor Q1, causing the transistor Q1 to amplify the flowing current.

Optionally, after the transistor Q1 amplifies the current flowing through it, the amplified current may be directly input into the comparison circuit U1, the comparison circuit U1 may compare the amplified current with a reference current to output a comparison signal. After the transistor Q1 amplifies the current flowing through it, the amplified current may be applied to a resistor to generate a voltage drop across the resistor, i.e., converting the amplified current into the voltage, which is then input into the comparison circuit U1. The comparison circuit U1 may compare the converted voltage with a reference voltage to output a comparison signal.

The above embodiments are described using the comparison module 1211 as an example, and they may be similarly applied to other comparison modules of the connection detection circuit 12.

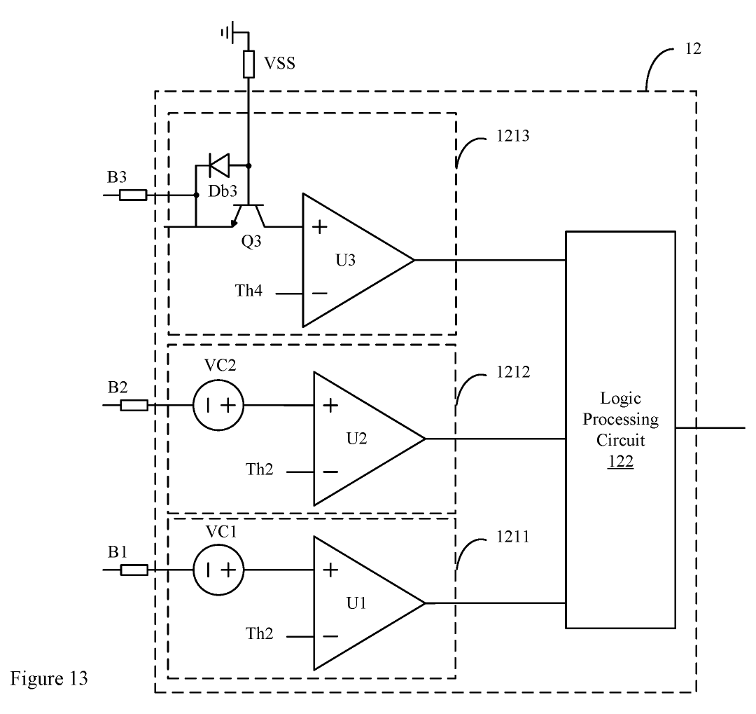

In some embodiments, referring to FIGS. 8 and 13, in a case where the battery management chip 10 includes only three second pins, B1, B2 and B3, and the second pins B1, B2, and B3 are arbitrarily connected to the common terminals of the corresponding batteries in the battery pack 20, the connection detection circuit 12 may include three comparison modules comprising the comparison module 1211, the comparison module 1212 and a comparison module 1213, and the logic processing circuit 122. The comparison module 1211 corresponds to the second pin B1, the comparison module 1212 corresponds to the second pin B2, and the comparison module 1213 corresponds to the second pin B3.

The comparison module 1211 may be configured to receive the voltage or substrate current of the second pin B1 to output a comparison signal S1. The comparison module 1212 may be configured to receive the voltage or substrate current of the second pin B2 to output a comparison signal S2. The comparison module 1213 may be configured to receive the voltage or substrate current of the second pin B3 to output a comparison signal S3.

The logic processing circuit 122 may be configured to receive the comparison signal S1, the comparison signal S2 and the comparison signal S3, and perform logic processing on the comparison signal S1, the comparison signal S2 and the comparison signal S3 to output control signals.

Exemplarily, the logic processing circuit 122 may be an AND gate logic circuit. After receiving the comparison signal S1, the comparison signal S2 and the comparison signal S3, the logic processing circuit 122 may perform AND logic processing on the comparison signal S1, the comparison signal S2 and the comparison signal S3. If the comparison signal S1, comparison signal S2 and comparison signal S3 are all high, the control signal output by the logic processing circuit 122 may be used to control the main circuit 11 to turn on, indicating that the lowest voltage terminal of the battery pack 20 is connected to the third pin VSS at this time. If the comparison signal S1 is low and both the comparison signal S2 and the comparison signal S3 are high, the control signal output by the logic processing circuit 122 may be used to control the main circuit 11 to turn off, indicating that the lowest voltage terminal of the battery pack 20 is not connected to the third pin VSS at this time.

In one embodiment, as shown in FIG. 13, the comparison module 1211 is used to receive the voltage of the second pin B1, the comparison module 1212 is used to receive the voltage of the second pin B2, and the comparison module 1213 is used to receive the substrate current of the second pin B3.

In this embodiment, the comparison module 1211 may include a first voltage source VC1 and a comparison circuit U1, and is configured to compare a first superimposed voltage, which is the voltage of the second pin B1 superimposed on the voltage of the first voltage source VC1, with a second reference signal Th2 and output the comparison signal S1. The comparison module 1212 may include a second voltage source VC2 and a comparison circuit U2, and is configured to compare a second superimposed voltage, which is the voltage of the second pin B2 superimposed on the voltage of the second voltage source VC2, with the second reference signal Th2 and output the comparison signal S2. The comparison module 1213 may include a current amplifier circuit Q3 and a comparison circuit U3, and is configured to compare an amplified current signal obtained after amplifying the substrate current of the second pin B3 with a fourth reference signal Th4 and output the comparison signal S3.

It should be noted that the comparison module 1211 and the comparison module 1212 may also be used to receive the substrate current of the second pin B1 and the second pin B2, respectively, and may be replaced with the circuit structure in FIG. 12, respectively. The comparison module 1211 and the comparison module 1212 may also be replaced with the circuit structure as shown in FIGS. 9 or 11, respectively, and are used to receive the voltages of the second pin B1 and the second pin B2, respectively. The comparison module 1213 may also be used to receive the voltage of the second pin B3, and may be replaced with the circuit structure in FIGS. 9, 10 or 11. Furthermore, the specific methods and combinations used by these three comparison modules to respectively receive the voltages or substrate currents of the corresponding second pins may be configured according to specific circumstances, and the present disclosure is not limited herein.

Embodiments of the present disclosure also provide a connection detection method, the operating principle thereof may be referred to the description of the operating principle of the connection detection circuit in the above mentioned embodiments and will not be elaborated herein.

Although the embodiments are described and illustrated separately above, those ordinarily skilled in the art would recognize that, certain involved common technologies may be replaced or integrated between the embodiments, and for content not explicitly described in one embodiment, reference may be made to another embodiment that has the content described.

The embodiments described above do not constitute a limitation on the protection scope of the technical solutions. Any modifications, equivalent substitutions, and improvements made within the spirit and principles of the above mentioned embodiments should be included within the protection scope of the technical solution.

Although the description has been described in detail, it should be understood that various changes, substitutions and alterations can be made without departing from the spirit and scope of this disclosure as defined by the appended claims. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, which may perform substantially the same function or achieve substantially the same result as the corresponding embodiments described herein, may be utilized according to the present disclosure. Accordingly, the appended claims are intended to include within their scope such processes, machines, manufacture, compositions of matter, means, methods, or steps.

What is claimed:

1. A circuit applied to a battery management system,
the battery management system comprising a battery pack and a battery management chip, the battery pack comprising at least two batteries, the battery management chip comprising a main circuit, a first pin, at least one second pin and a third pin, and the third pin being connected to a reference ground of the main circuit,
the first pin being configured to connect to a highest voltage terminal of the battery pack, the at least one second pin being configured to connect to a negative terminal of a battery in the battery pack, and the third pin being configured to connect to a lowest voltage terminal of the battery pack, and
the circuit comprising:
at least one comparison module corresponding one-to-one to the at least one second pin, the at least one comparison module being configured to output at least one comparison signal based on a voltage or a substrate current of the at least one second pin; and
wherein the circuit is configured to:
generate a control signal indicating whether the lowest voltage terminal of the battery pack is connected to the third pin based on the at least one comparison signal;
when the control signal indicates that the lowest voltage terminal of the battery pack is not connected to the third pin, control to turn off the main circuit; and
when the control signal indicates that the lowest voltage terminal of the battery pack is connected to the third pin, control to turn on the main circuit.

2. The circuit of claim 1, wherein the at least one second pin is configured to connect to a common terminal between batteries of the battery pack; or
one of the at least one second pin is configured to connect to the lowest voltage terminal of the battery pack, and remaining second pin(s) is/are connected to common terminal(s) between batteries of the battery pack.

3. The circuit of claim 1, wherein each of the at least one second pin is connected to a substrate parasitic diode; and
the circuit is further configured to:
when detecting that the voltage of the at least one second pin is negative, or when detecting that the substrate current flows through at least one substrate parasitic diode, determine that the lowest voltage terminal of the battery pack is not connected to the third pin; and
when detecting no negative voltage at the at least one second pin, and no substrate current flowing through the substrate parasitic diode, determine that the lowest voltage terminal of the battery pack is connected to the third pin.

4. The circuit of claim 1, wherein each of the at least one comparison module is configured to receive a voltage of a corresponding second pin or receive a first signal indicating a substrate current of the corresponding second pin, and output a comparison signal; and
the circuit further comprises:
a logic processing circuit, configured to receive the at least one comparison signal output by the at least one comparison module, and perform logic processing to generate the control signal.

5. The circuit of claim 4, wherein a comparison module of the at least one comparison module is configured to receive the voltage of the corresponding second pin; and
the comparison module comprises a comparison circuit having a first input terminal receiving the voltage of the corresponding second pin, and a second input terminal receiving a first reference signal, the comparison circuit being configured to compare the voltage of the corresponding second pin and the first reference signal to output the comparison signal; or
the comparison module comprises:
a first voltage source having a first polarity terminal receiving the voltage of the corresponding second pin, and a second polarity terminal outputting a first superimposed voltage being superimposition of the voltage of the corresponding second pin and a voltage of the first voltage source, and
a comparison circuit having a first input terminal receiving the first superimposed voltage, and a second input terminal receiving a second reference signal, the comparison circuit being configured to compare the first superimposed voltage and the second reference signal to output the comparison signal; or
the comparison module comprises:
a first adder configured to add the voltage of the corresponding second pin and a bias voltage to output a second superimposed voltage; and
a comparison circuit, having a first input terminal receiving the second superimposed voltage, and a second input terminal receiving a third reference signal, the comparison circuit being configured to compare the second superimposed voltage and the third reference signal to output the comparison signal.

6. The circuit of claim 4, wherein a comparison module of the at least one comparison module is configured to receive the first signal, and the comparison module comprises:
a current amplification circuit connected to the third pin and the corresponding second pin, the current amplification circuit being configured to receive the first signal, and amplify the first signal to obtain an amplified current signal indicating the substrate current of the corresponding second pin; and
a comparison circuit having a first input terminal receiving the amplified current signal and a second input terminal receiving a fourth reference signal, the comparison circuit being configured to compare the amplified current signal and the fourth reference signal to output the comparison signal.

7. The circuit of claim 6, wherein the current amplification circuit comprises:
a transistor, having a control terminal connected to the third pin, a first terminal connected to the corresponding second pin, and a second terminal connected to the first input terminal of the comparison circuit, and the amplified current signal is obtained based on a current flowing through the transistor.

8. The circuit of claim 1, wherein the control signal is connected to an enable signal input terminal of the main circuit to control whether to enable the main circuit.

9. The circuit of claim 1, wherein the battery management system comprises a first switch connected between the main circuit and the first pin;
controlling to turn off the main circuit comprises:
controlling to open the first switch based on the control signal when the lowest voltage terminal of the battery pack is not connected to the third pin, to turn off the main circuit; and
controlling to turn on the main circuit comprises:
controlling to close the first switch based on the control signal when the lowest voltage terminal of the battery pack is connected to the third pin, to turn on the main circuit.

10. A method applied to a battery management system,
the battery management system comprising a battery pack and a battery management chip, the battery pack comprising at least two batteries, and the battery management chip comprising a main circuit, a first pin, at least one second pin, and a third pin, the first pin being configured to connect to a highest voltage terminal of the battery pack, the at least one second pin being configured to connect to a common terminal between the at least two batteries of the battery pack, and the third pin being configured to connect to a lowest voltage terminal of the battery pack, and
the method comprising:
detecting a voltage or a substrate current of the at least one second pin, and based thereon, determining whether the lowest voltage terminal of the battery pack is connected to the third pin;
when determining that the lowest voltage terminal of the battery pack is not connected to the third pin, controlling to turn off the main circuit; and
when determining that the lowest voltage terminal of the battery pack is connected to the third pin, controlling to turn on the main circuit.

11. The method of claim 10, wherein the at least one second pin is connected to a substrate parasitic diode, and
determining whether the lowest voltage terminal of the battery pack is connected to the third pin comprises:
when detecting that the voltage of the at least one second pin is a negative voltage, or when detecting that the substrate current flows through the substrate parasitic diode, determining that the lowest voltage terminal of the battery pack is not connected to the third pin; and
when detecting that the voltage of the at least one second pin is not a negative voltage, and no substrate current flows through the substrate parasitic diode, determining that the lowest voltage terminal of the battery pack is connected to the third pin.

12. The method of claim 10, wherein detecting the voltage or the substrate current of the at least one second pin to determine whether the lowest voltage terminal of the battery pack is connected to the third pin includes:
respectively comparing the voltage of the at least one second pin with a first reference signal to obtain at least one comparison result; or
respectively superimposing the voltage of the at least one second pin and a first voltage source to obtain at least one first superimposed voltage, and respectively comparing the at least one first superimposed voltage with a second reference signal to obtain at least one comparison result; or
respectively adding the voltage of the at least one second pin and a bias voltage to obtain at least one second superimposed voltage, and respectively comparing the at least one second superimposed voltage with a third reference signal to obtain at least one comparison result; or
respectively amplifying at least one first signal representing the substrate current of the at least one second pin to obtain at least one amplified current signal respectively representing the substrate current of the at least one second pin, and respectively comparing the at least one amplified current signal with a fourth reference signal to obtain at least one comparison result;
determining whether the lowest voltage terminal of the battery pack is connected to the third pin based on the at least one comparison result.

13. A battery management chip, comprising:
a first pin, configured to connect to a highest voltage terminal of a battery pack;
at least one second pin, configured to connect to a negative terminal of a battery of the battery pack;
a third pin, configured to connect to a lowest voltage terminal of the battery pack;
a main circuit, connected to the first pin and the at least one second pin, wherein the third pin is connected to a reference ground of the main circuit; and
a detection circuit connected to the at least one second pin and the main circuit, the detection circuit being configured to:
generate a control signal indicating whether the lowest voltage terminal of the battery pack is connected to the third pin, based on a voltage or a substrate current of the at least one second pin;
when the control signal indicates that the lowest voltage terminal of the battery pack is not connected to the third pin, control to turn off the main circuit; and
when the control signal indicates that the lowest voltage terminal of the battery pack is connected to the third pin, control to turn on the main circuit.

14. The battery management chip of claim 13, wherein the at least one second pin is configured to connect to a common terminal between batteries of the battery pack; or
one of the at least one second pin is connected to the lowest voltage terminal of the battery pack, and remaining second pin(s) is/are connected to common terminal(s) between batteries of the battery pack.

15. The battery management chip of claim 13, wherein each of the at least one second pin is connected to a substrate parasitic diode; and
the detection circuit is further configured to:
when detecting that negative voltage at the at least one second pin, or when detecting current flowing through the substrate parasitic diode, determine that the lowest voltage terminal of the battery pack is not connected to the third pin; and
when detecting no negative voltage at the at least one second pin, and no current flowing through the substrate parasitic diode, determine that the lowest voltage terminal of the battery pack is connected to the third pin.

16. The battery management chip of claim 13, wherein the detection circuit comprises:
at least one comparison module corresponding one-to-one to the at least one second pin, the at least one comparison module being configured to output at least one comparison signal based on the voltage or a first signal indicating the substrate current of the at least one second pin; and
a logic processing circuit, configured to receive the at least one comparison signal output by the at least one comparison module, and perform logic processing to generate the control signal.

17. The battery management chip of claim 16, wherein a comparison module of the at least one comparison module is configured to receive the voltage of a corresponding second pin; and
the comparison module comprises a comparison circuit having a first input terminal receiving the voltage of the corresponding second pin, and a second input terminal receiving a first reference signal, the comparison circuit being configured to compare the voltage of the corresponding second pin and the first reference signal to output a comparison signal; or
the comparison module comprises:
a first voltage source having a first polarity terminal receiving the voltage of the corresponding second pin, and a second polarity terminal outputting a first superimposed voltage being superimposition of the voltage of the corresponding second pin and a voltage of the first voltage source, and
a comparison circuit having a first input terminal receiving the first superimposed voltage, and a second input terminal receiving a second reference signal, the comparison circuit being configured to compare the first superimposed voltage and the second reference signal to output a comparison signal; or
the comparison module comprises:
a first adder configured to add the voltage of the corresponding second pin and a bias voltage to output a second superimposed voltage; and
a comparison circuit, having a first input terminal receiving the second superimposed voltage, and a second input terminal receiving a third reference signal, the comparison circuit being configured to compare the second superimposed voltage and the third reference signal to output a comparison signal.

18. The battery management chip of claim 16, wherein a comparison module of the at least one comparison module is configured to receive the first signal, and the comparison module comprises:
a current amplification circuit connected to the third pin and the corresponding second pin, the current amplification circuit being configured to receive the first signal, and amplify the first signal to obtain an amplified current signal indicating the substrate current of the corresponding second pin; and
a comparison circuit having a first input terminal receiving the amplified current signal and a second input terminal receiving a fourth reference signal, the comparison circuit being configured to compare the amplified current signal and the fourth reference signal to output a comparison signal.

19. A battery management system, comprising the battery management chip of claim 13.

20. A battery management system, comprising the battery management chip of claim 13 and the battery pack.
